(19) United States
(12) Patent Application Publication
(10) Pub. No.: US 2015/0079513 A1
(43) Pub. Date: Mar. 19, 2015

(54) TONER FOR ELECTROSTATIC IMAGE DEVELOPMENT, TWO-COMPONENT DEVELOPER FOR REPLENISHING, IMAGE-FORMATION METHOD USING SAME, AND IMAGE-FORMATION DEVICE

(71) Applicant: SHARP KABUSHIKI KAISHA, Osaka-shi, Osaka (JP)

(72) Inventors: Shintaro Fukuoka, Osaka-shi (JP); Tadayuki Sawai, Osaka-shi (JP); Yoritaka Tsubaki, Osaka-shi (JP); Keiichi Kikawa, Osaka-shi (JP); Keigo Mitamura, Osaka-shi (JP); Yui Kawano, Osaka-shi (JP)

(21) Appl. No.: 14/384,323

(22) PCT Filed: Mar. 8, 2013
(86) PCT No.: PCT/JP2013/056507

§ 371 Date: Sep. 10, 2014

(30) Foreign Application Priority Data
Mar. 14, 2012 (JP) 2012-057921

(51) Int. Cl. G03G 9/107; G03G 9/087

(52) U.S. Cl. CPC G03G 9/1075; G03G 9/08755
USPC 430/108.4; 399/252; 430/124.1

(57) ABSTRACT

A toner for electrostatic image development is configured such that: a binder resin is polyester resin; a release agent dispersing aid is styrene acrylic copolymer resin having at least one of an α-methylstyrene structure and a styrene structure, and is contained in an amount of 5.5 parts by weight to 12 parts by weight with respect to 100 parts by weight of the polyester resin; and the styrene acrylic copolymer resin has an acid value of 3 KOHmg/g to 9 KOHmg/g, and the toner for electrostatic image development has an acid value of 14 KOHmg/g to 19 KOHmg/g.

### TECHNICAL FIELD

The present invention relates to a toner for electrostatic image development and a two component developer for supply each of which is supplied to, for example, an electrophotographic image forming apparatus, and an image forming method and an image forming apparatus each using the toner for electrostatic image development or the two component developer for supply.

### BACKGROUND ART

A developing device which visualizes (develops), by use of a two component developer (hereinafter may be referred to merely as a developer) containing a carrier and toner, an electrostatic latent image on a surface of a photoreceptor (image bearing member) is frequently used in an electrophotographic image forming apparatus. In the case of such a developing device that uses a two component developer, toner is sequentially consumed by a development operation, whereas a carrier remains in the developing device without being consumed. Therefore, the carrier which is stirred together with the toner in the developing device deteriorates due to spent such as peel-off of a resin coating layer on a surface of the carrier and/or adhesion of the toner to the surface of the carrier as the stirring is more frequently carried out. This causes a gradual deterioration in charging performance.

For example, Patent Literature 1 discloses, as means for solving such a problem as described earlier, a trickle developing system developing device (hereinafter referred to as a trickle developing device) configured to prevent a deterioration in charging performance of a developer by replacing a carrier having deteriorated with a new carrier by gradually supplying, to the developing device, not only toner to be consumed by a development operation but also a carrier.

According to a trickle developing device, a developer (mixture of toner and a carrier) in a developing tank which developer has become excessive by supply of the carrier is discharged by overflow via an overflow opening provided on a wall surface of the developing tank. In a case where the supply and the discharge are successively repeated, the carrier which is contained in the developing tank and has deteriorated is replaced with a new carrier. This makes it possible to maintain charging performance of the toner and to prevent a deterioration in image quality. Increasingly, such a trickle developing device is being provided in an image forming apparatus which is capable of carrying out a process at a high speed (hereinafter referred to as a high speed machine).

Meanwhile, toner which is contained in a two component developer is resin particles whose parent body is a binder resin such as polyester resin. The toner is obtained by causing the binder resin to contain, for example, a coloring agent, a charging control agent, a release agent, and a release agent dispersing aid. Toners of three colors that are cyan, magenta, and yellow are used to form a full-color image, and a black toner may be used in addition to these toners.

For example, Patent Literature 2 discloses that toners of cyan, magenta, and yellow each contain polyester resin as a binder resin, a coloring agent, and a grinding aid, and a copolymer resin containing a styrene monomer and an indene monomer is used as the grinding aid. Patent Literature 2 also discloses that the grinding aid is contained in an amount of 1 part by weight to 20 parts by weight, and more preferably of 3 parts by weight to 15 parts by weight, with respect to 100 parts by weight of the binder resin. According to Patent Literature 2, the toners of the respective colors can be made identical in grindability.

### CITATION LIST

### Patent Literatures

Patent Literature 1
Japanese Examined Patent Application Publication, Tokukohei, No. 2-21591 (Publication Date: May 15, 1990)

Patent Literature 2
Japanese Patent Application Publication, Tokukai, No. 2000-231219 (Publication Date: Aug. 22, 2000)

### SUMMARY OF INVENTION

### Technical Problem

A high speed machine in which a trickle developing device is provided prints many sheets. Therefore, such a high speed machine is required to have a longer life (be used for a long term). However, the toners disclosed in Patent Literature 2 are not toners that have been developed so as to be specialized in improvement in image quality especially in a latter half of a life of the trickle developing device. Therefore, a copolymer resin is used to improve grindability. However, use of a copolymer resin in a trickle developing device causes a deterioration in charged amount of toner, and causes toner scattering and photographic fog due to a broadened charge distribution. This is a problem unique to a trickle developing device. A new carrier which has been supplied to a development layer and an old carrier which has already been used coexist in a trickle developing device. It goes without saying that the new carrier and the old carrier differ in capability of charging toner. This causes a difference in charged amount of toner and a difference in developability. Note that the problem can also be solved by replacing larger amounts of carriers more frequently. However, this results in disposal of a larger amount of a developer.

An object of the present invention is to provide toner and a two component developer for supply each of which, by being used in a trickle developing system developing device, is capable of improving an image quality in a latter half of a life of the trickle developing system developing device while reducing toner scattering and photographic fog, and an image forming method and an image forming apparatus each using the toner or the two component developer for supply.

### Solution to Problem

As a result of diligent study to attain the object, inventors of the present invention found that an image quality can be improved in a latter half of a life of a trickle developing device by adding, to polyester resin serving as a binder resin, styrene acrylic copolymer resin in a given ratio, and adjusting an acid value of the styrene acrylic copolymer resin and an acid value of toner to fall within respective given ranges. The finding allowed the inventors to work the present invention.

That is, in order to attain the object, a toner for electrostatic image development of the present invention for use in a trickle developing system developing device, contains: a binder resin; a coloring agent; a charging control agent; a release agent; and a release agent dispersing aid, the binder resin being polyester resin, the release agent dispersing aid being styrene acrylic copolymer resin having at least one of an α-methylstyrene structure and a styrene structure, the release agent dispersing aid being contained in an amount of 5.5 parts by weight to 12 parts by weight with respect to 100 parts by weight of the polyester resin, and the styrene acrylic copolymer resin having an acid value of 3 KOHmg/g to 9 KOHmg/g, and the toner for electrostatic image development having an acid value of 14 KOHmg/g to 19 KOHmg/g.

Toner having the configuration makes it possible to prevent a deterioration in carrier. This allows (i) prevention of a decrease in charged amount, toner scattering, and a deterioration in developability in the trickle developing system developing device and (ii) an increase in image quality in a latter half of a life of the trickle developing system developing device.

The styrene acrylic copolymer resin which is contained as the release agent dispersing aid and has at least one of the α-methylstyrene structure and the styrene structure is present so as to surround the release agent. The release agent which is surrounded by the styrene acrylic copolymer resin is less likely to be exposed on a surface of the toner. This makes it possible to prevent a deterioration in carrier due to sticking, to a carrier, the release agent separated from the toner. Further, it is considered that the styrene acrylic copolymer resin, which also functions as the release agent dispersing aid, yields a higher effect.

In addition, the release agent and the styrene acrylic copolymer resin surrounding the release agent are integrated during grinding so as to be a large grinding interface. This allows the styrene acrylic copolymer resin to be easily present on the surface of the toner, so that the polyester resin is present on the surface of the toner in a lower ratio. As a result, the toner has lower moisture absorbency in a high-temperature and high-humidity environment. This makes it possible to obtain a sufficient charged amount in the high-temperature and high-humidity environment, so that stable chargeability can be secured.

Note, however, that in order to obtain such an effect, the styrene acrylic copolymer resin needs to be contained in an amount of 5.5 parts by weight to 12 parts by weight with respect to 100 parts by weight of the polyester resin. In a case where the styrene acrylic copolymer resin is contained in an amount below the above range, the release agent is less dispersible, and the release agent is separated from the toner in a larger amount, so that the carrier is contaminated. In a case where more carriers are contaminated, there appears a difference in charged amount and developability between the contaminated carriers and a new and uncontaminated carrier, and there occur charging characteristics, toner scattering, photographic fog, etc. Meanwhile, in a case where the styrene acrylic copolymer resin is contained in an amount beyond the above range, the release agent is too dispersible, so that necessary separability cannot be obtained at a high temperature. This causes a deterioration in fixability.

In addition, it is necessary that the styrene acrylic copolymer resin have an acid value of 3 KOHmg/g to 9 KOHmg/g and that the toner have an acid value of 14 KOHmg/g to 19 KOHmg/g. In a case where the styrene acrylic copolymer resin has an acid value within the above range, an effect of reducing separation of the release agent from the toner can be secured by surrounding of the release agent by the styrene acrylic copolymer resin. The styrene acrylic copolymer resin which has an acid value beyond the above range is compatible with the polyester resin serving as the binder resin. This prevents the effect of the styrene acrylic copolymer resin from being shown. In contrast, in a case where the styrene acrylic copolymer resin has an acid value below the above range, the styrene acrylic copolymer resin is not properly compatible with the polyester resin serving as the binder resin. This causes wax to be less dispersible and causes a deterioration in fixing performance.

Meanwhile, in a case where the styrene acrylic copolymer resin has an acid value of 3 KOHmg/g to 9 KOHmg/g but the toner has an acid value beyond the above range, it is impossible to stabilize charging and prevent toner scattering and photographic fog. This is because of the following reason. Assume that an acid value of the styrene acrylic copolymer resin and a ratio of the styrene acrylic copolymer resin to the binder resin are set. In this case, when the binder resin, which accounts for most of the toner, has a too high acid value, moisture absorbency of the toner is not improved, so that chargeability deteriorates. In contrast, when the binder resin has a too low acid value, charging is too high, so that photographic fog occurs. That is, in order to stabilize charging and prevent toner scattering and photographic fog, it is necessary to use a binder resin which causes the toner to have an acid value within the above range.

### Advantageous Effects of Invention

The present invention which, by being used in a trickle developing system developing device, is capable of improving an image quality in a latter half of a life of the trickle developing system developing device while reducing toner scattering and photographic fog.

### BRIEF DESCRIPTION OF DRAWINGS

FIG. 1 an explanatory drawing showing an example of configuration of an image forming apparatus in accordance with an embodiment of the present invention.

FIG. 2 is an explanatory drawing of a trickle developing system developing device provided in the image forming apparatus.

### DESCRIPTION OF EMBODIMENTS

### Image Forming Apparatus

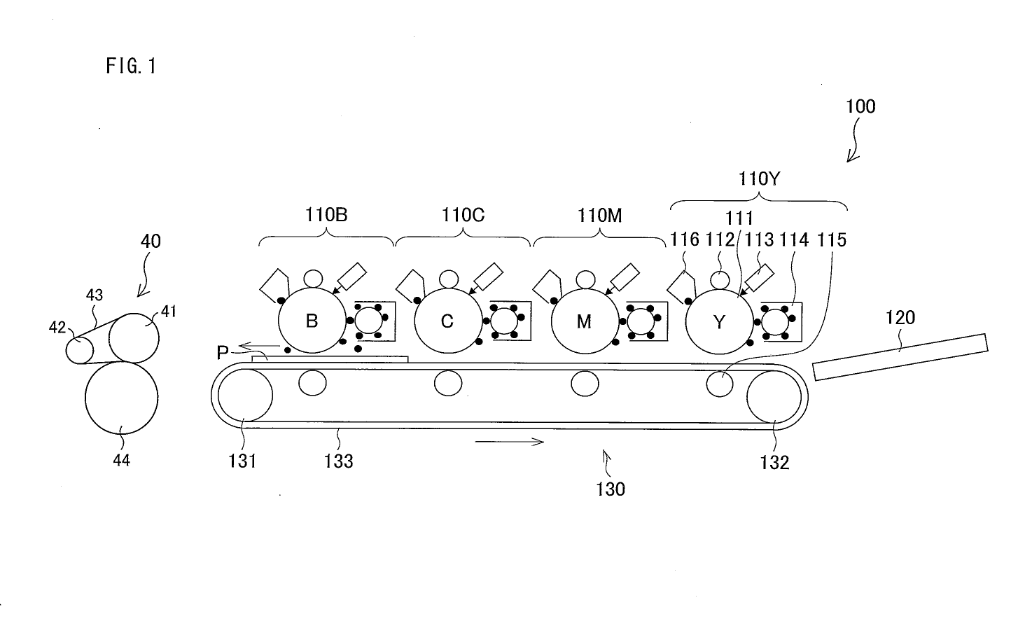

FIG. 1 an explanatory drawing showing an example of configuration of an image forming apparatus which uses a toner of the present invention.

An image forming apparatus 100, which is an electrophotographic printer, is a so-called tandem printer including four visible image forming units (a yellow visible image forming unit 110Y, a magenta visible image forming unit 110M, a cyan visible image forming unit 110C, and a black visible image forming unit 110B which are also collectively referred to as “a visible image forming unit 110”) which are provided along a recording paper conveying path.

Specifically, four visible image forming units 110 are provided along a conveying path for recording paper P which conveying path is provided between a feeding tray 120 for feeding the recording paper P (a transfer medium, a recording medium) and a fixing device 40. The visible image forming units 110 transfer, to the recording paper P which is carried by a carrying belt 133 being endless and serving as recording paper carrying means 130, toner images of the respective colors so that the toner images overlap each other. Then, a fixing device 40 fixes the toner images to the recording paper P, so that a full-color image is formed.

The carrying belt 133 is provided in a tensioned state by a drive roller 131 and an idle roller 132. The carrying belt 133 circles these rollers while being controlled at a predetermined peripheral velocity (approximately 150 to 400 mm/sec, e.g., 220 mm/sec). The recording paper P is carried by electrostatically adsorbing to the carrying belt 133.

The visible image forming units 110 each include a photoreceptor drum 111, and a charging roller 112, exposure means (laser light irradiation means) 113, a developing device 114, a transfer roller 115, and a cleaner 116 which are provided around the photoreceptor drum 111.

A developer containing a yellow toner is contained in the developing device 114 of the visible image forming unit 110Y. A developer containing a magenta toner is contained in the developing device 114 of the visible image forming unit 110M. A developer containing a cyan toner is contained in the developing device 114 of the visible image forming unit 110C. A developer containing a black toner is contained in the developing device 114 of the visible image forming unit 110B.

A toner image is transferred to the recording paper P in each of the visible image forming units 110. The following discusses how the transfer is carried out. First, a surface of the photoreceptor drum 111 is uniformly charged by the charging roller 112. Thereafter, an electrostatic latent image is formed by causing the laser light irradiation means 113 to expose the surface of the photoreceptor drum 111 to a laser in accordance with image information. Then, the developing device 114 supplies the toner to the electrostatic latent image on the photoreceptor drum 111. According to this, the electrostatic latent image is developed (made visible), so that a toner image is generated. Subsequently, the transfer roller 115 applied with a bias voltage whose polarity is reverse to a polarity of the toner of the toner image sequentially transfers, to the recording paper P which is carried by the carrying belt (carrying means) 130, the toner image generated on the surface of the photoreceptor drum 111.

Thereafter, the recording paper P is detached from the carrying belt 133 at a curved part (part at which the carrying belt 133 is wound on the drive roller 131) and then carried to the fixing device 40. The fixing device 40 includes a heat roller 41, a detachment roller 42, a fixing belt 43 which is endless, is provided in a tensioned state by the heat roller 41 and the detachment roller 42, and is driven to circle these rollers by rotation of the rollers, and a pressure roller 44 which is pressure-joined with the heat roller 41 via the fixing belt 43. The recording paper P is carried to a space between the fixing belt 43 and the pressure roller 44, and a moderate temperature and a moderate pressure are applied to the recording paper P. According to this, the toner of the recording paper P is melted, the toner is fixed to the recording paper P, so that a fast image is formed on the recording paper P. An angle α formed by the recording paper P having passed through a transfer nip and the fixing belt 43 having passed through the transfer nip is a detachment angle.

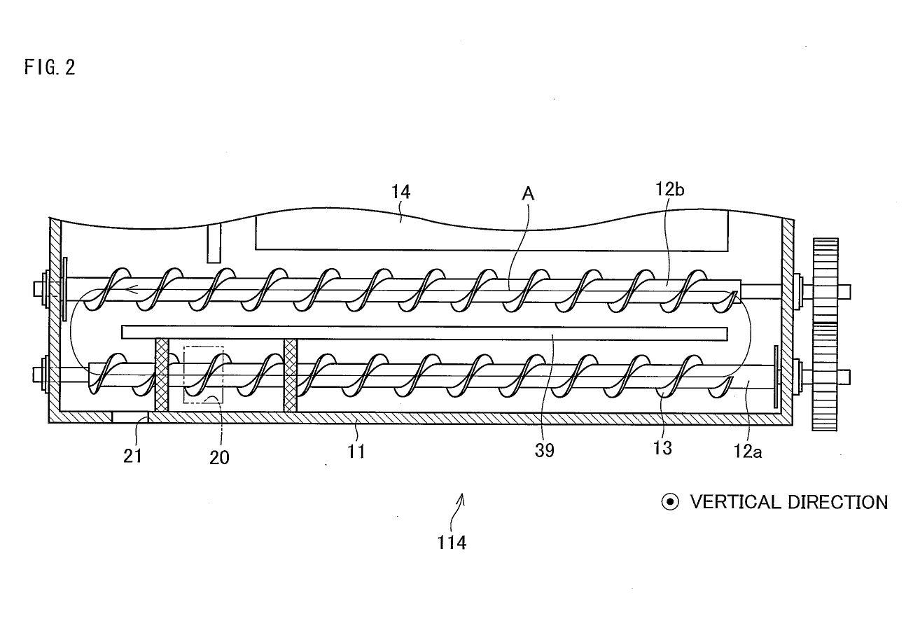

The developing device 114, which is a trickle developing system developing device, is configured such that a carrier together with a developer is supplied from a developer hopper (not illustrated) to the developing device 114. As illustrated in FIG. 2, the developing device 114 includes a developing tank 11 in which a developing roller 14, and a first carrying screw 12a and a second carrying screw 12b (stirring carrying members) are provided. The developing tank 11 is provided with a developer supply opening 20 and a developer overflow opening 21. FIG. 2 is a plan view of a relevant part of the developing device 114 seen from above in a vertical direction.

The developing tank 11 is a container in which a two component developer (hereinafter referred to as a developer) containing toner and a carrier is contained. The developing roller 14 supplies, to the photoreceptor drum 111 (see FIG. 1), the toner contained in the developing tank 11, and is made of a magnet roller.

Each of the first carrying screw 12a and the second carrying screw 12b carries the developer by stirring so as to supply the developer to the developing roller 14, and is provided with a stirring blade 13. A space between the first carrying screw 12a and the second carrying screw 12b is partitioned off by a blocking wall 39. While being stirred by the first carrying screw 12a and the second carrying screw 12b, the developer contained in the developing tank 11 is carried by circulation in a direction shown by an arrow A. While being carried, the toner contained in the developer which is being carried rubs against the carrier so as to be triboelectrically charged.

The toner which is contained in the developer and has been triboelectrically charged is born by a surface of the developing roller 14 while being carried by circulation, and is provided to the photoreceptor drum 111 so as to be consumed. Together with a carrier, new toner is supplied to the developing tank 11 via the supply opening 20 provided above the first carrying screw 12a. The developer which is contained in the developing tank 11 and has increased by the supply of the carrier is discharged by overflow from the developing tank 11 via the developer overflow opening 21. The discharged developer is collected in a collection container such as a waste toner box (not illustrated).

<Toner>

The following description discusses components of a toner of the present invention.

The toner of the present invention is colored cyan, magenta, yellow, black, or the like. The toner contains: a binder resin; a coloring agent; a charging control agent; a release agent; and a release agent dispersing aid. The binder resin is polyester resin, and the release agent dispersing aid is styrene acrylic copolymer resin having at least one of an α-methylstyrene structure and a styrene structure. The styrene acrylic copolymer resin is contained in an amount of 5.5 parts by weight to 12 parts by weight with respect to 100 parts by weight of the polyester resin. The styrene acrylic copolymer resin has an acid value HZ of 3 KOHmg/g to 9 KOHmg/g, and the toner for electrostatic image development has an acid value of 14 KOHmg/g to 19 KOHmg/g.

The configuration makes it possible to prevent a deterioration in carrier. This allows (i) prevention of a decrease in charged amount, toner scattering, and a deterioration in developability in the trickle developing system developing device and (ii) an increase in image quality in a latter half of a life of the trickle developing system developing device.

The styrene acrylic copolymer resin which is contained as the release agent dispersing aid and has at least one of the α-methylstyrene structure and the styrene structure is present so as to surround the release agent.

The release agent which is surrounded by the styrene acrylic copolymer resin is less likely to be exposed on a surface of the toner. This makes it possible to prevent a deterioration in carrier due to sticking, to a carrier, the release agent separated from the toner. Further, it is considered that the styrene acrylic copolymer resin, which also functions as the release agent dispersing aid, yields a higher effect.

In addition, the release agent and the styrene acrylic copolymer resin surrounding the release agent are integrated during grinding so as to be a large grinding interface. This allows the styrene acrylic copolymer resin to be easily present on the surface of the toner, so that the polyester resin is present on the surface of the toner in a lower ratio. As a result, the toner has lower moisture absorbency in a high-temperature and high-humidity environment. This makes it possible to obtain a sufficient charged amount in the high-temperature and high-humidity environment, so that stable chargeability can be secured.

However, in order to obtain such an effect, the styrene acrylic copolymer resin needs to be contained in an amount of 5.5 parts by weight to 12 parts by weight with respect to 100 parts by weight of the polyester resin. In a case where the styrene acrylic copolymer resin is contained in an amount below the above range, the release agent is less dispersible, and the release agent is separated from the toner in a larger amount, so that the carrier is contaminated. In a case where more carriers are contaminated, there appears a difference in charged amount and developability between the contaminated carriers and a new and uncontaminated carrier, and there occur charging characteristics, toner scattering, photographic fog, etc. Meanwhile, in a case where the styrene acrylic copolymer resin is contained in an amount beyond the above range, the release agent is too dispersible, so that necessary separability cannot be obtained at a high temperature. This causes a deterioration in fixability.

In addition, it is necessary that the styrene acrylic copolymer resin have an acid value of 3 KOHmg/g to 9 KOHmg/g and that the toner have an acid value of 14 KOHmg/g to 19 KOHmg/g. In a case where the styrene acrylic copolymer resin has an acid value within the above range, an effect of reducing separation of the release agent from the toner can be secured by surrounding of the release agent by the styrene acrylic copolymer resin. The styrene acrylic copolymer resin which has an acid value beyond the above range is compatible with the polyester resin serving as the binder resin. This prevents the effect of the styrene acrylic copolymer resin from being shown. In contrast, in a case where the styrene acrylic copolymer resin has an acid value below the above range, the styrene acrylic copolymer resin prevents wax from being properly dispersed and causes a deterioration in fixing performance.

Meanwhile, in a case where the styrene acrylic copolymer resin has an acid value of 3 KOHmg/g to 9 KOHmg/g but the toner has an acid value beyond the above range, it is impossible to stabilize charging and prevent toner scattering and photographic fog. This is because of the following reason. Assume that an acid value of the styrene acrylic copolymer resin and a ratio of the styrene acrylic copolymer resin to the binder resin are set. In this case, when the binder resin, which accounts for most of the toner, has a too high acid value, moisture absorbency of the toner is not improved, so that chargeability deteriorates. In contrast, when the binder resin has a too low acid value, charging is too high, so that photographic fog occurs. That is, in order to stabilize charging and prevent toner scattering and photographic fog, it is necessary to use a binder resin which causes the toner to have an acid value within the above range.

A two component developer for supply of the present invention is a two component developer to be supplied to a trickle developing system developing device, containing: the toner for electrostatic image development of the present invention; and a ferrite carrier coated with a resin, the ferrite carrier being contained in an amount of 5 parts by weight to 18 parts by weight with respect to 100 parts by weight of the toner for electrostatic image development.

Note that besides the binder resin, the coloring agent, the charging control agent, the release agent, and the release agent dispersing aid, additives such as an electroconductivity adjusting agent, an extender pigment, an antioxidant, a flowability improving agent, a cleaning property improving agent, and the like may also be appropriately contained in the toner of the present invention.

(Binder resin) According to the toner for electrostatic image development of the present invention, the binder resin is polyester resin. Normally, the polyester resin is obtained by a publicly known method by subjecting, to a condensation polymerization reaction, esterification, or transesterification, one or more kind selected from a dihydric alcohol component and a tri- or more hydric polyhydric alcohol component, and one or more kind selected from divalent carboxylic acid and tri- or more valent multivalent carboxylic acid.

It is only necessary that a condition under which the condensation polymerization reaction is carried out be appropriately set in accordance with reactivity of a monomer component and that the reaction be ended when a polymer has a suitable physical property. For example, a reaction temperature is approximately 170° C. to 250° C., and a reaction pressure is approximately 5 mmHg to a normal pressure.

Examples of the dihydric alcohol component include alkylene oxide adducts of bisphenol A such as polyoxypropylene(2.2)-2,2-bis(4-hydroxyphenyl)propane, polyoxypropylene(3.3)-2,2-bis(4-hydroxyphenyl)propane, polyoxypropylene(2.0)-2,2-bis(4-hydroxyphenyl)propane, polyoxypropylene(20)-polyoxyethylene(2.0)-2,2-bis(4-hydroxyphenyl)propane, polyoxypropylene(6)-2,2-bis(4-hydroxyphenyl)propane, and the like; diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, and the like; bisphenol A; a propylene adduct of bisphenol A; an ethylene adduct of bisphenol A; hydrogenated bisphenol A; and the like.

Examples of the tri- or more hydric polyhydric alcohol component include sorbitol, 1,2,3,6-hexanetetrol, 1,4-sorbitan, pentaerythritol, dipentaerythritol, tripentaerythritol, sucrose (cane sugar), 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, and the like.

The dihydric alcohol components and the tri- or more hydric polyhydric alcohol components can be used alone by one kind or as a combination of two or more kinds in the toner of each of the colors.

Examples of the divalent carboxylic acid include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenyl succinic acid, n-dodecyl succinic acid, n-octyl succinic acid, isooctenyl succinic acid, isooctyl succinic acid, and anhydrides or lower alkyl esters of these acids, and the like.

Examples of the tri- or more valent multivalent carboxylic acid include 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxylic-2-methyl-2-methylenecarboxypropane, 1,2,4-cyclohexanetricarboxylic acid, tetra(methylene carboxyl)methane, 1,2,7,8-octanetetracarboxylic acid, pyromellitic acid, Empo1 trimer acid, and anhydrides or lower alkyl esters of these acids, and the like.

The divalent carboxylic acids and the tri- or more valent multivalent carboxylic acids can be used alone by one kind or as a combination of two or more kinds in the toner of each of the colors.

As described earlier, it is necessary that the toner have an acid value of 14 KOHmg/g to 19 KOHmg/g. Accordingly, in order to stabilize charging and prevent toner scattering of the toner and photographic fog, the polyester resin serving as the binder resin which accounts for most of the toner and determines a main physical property of the toner needs to have an acid value which causes the toner to have an acid value within the above range.

(Coloring Agent)

According to the toner for electrostatic image development of the present invention, the coloring agent for each of cyan, magenta, and yellow is exemplified by, but not particularly limited to a pigment and a dye for toner each of which is commonly used in an electrophotographic field. Examples of the pigment include: organic pigments such as an azo pigment, a benzimidazolone pigment, a quinacridone pigment, a phthalocyanine pigment, an isoindolinone pigment, an isoindoline pigment, a dioxazine pigment, an anthraquinone pigment, a perylene pigment, a perinone pigment, a thioindigo pigment, a quinophthalone pigment, a metal complex pigment, and the like; inorganic pigments such as carbon black, molybdenum red, chrome yellow, titanium yellow, chromium oxide, Berlin blue, and the like; and the like. Examples of the dye include azo dye, anthraquinone dye, chelate dye, squarylium dye, and the like.

The coloring agents may be used alone by one kind, or a plurality of same-colored coloring agents of the coloring agents can be used as a combination of two or more kinds. A contained amount of the coloring agent(s) is not particularly limited. Normally, the coloring agent(s) is/are contained in an amount of 3.0 parts by weight to 9.0 parts by weight with respect to 100 parts by weight of the binder resin.

(Charging Control Agent)

According to the toner for electrostatic image development of the present invention, the charging control agent is not particularly limited, provided that the charging control agent can charge the toner or control the charging of the toner. It is possible to use, as the charging control agent, a charging control agent which is commonly used in the electrophotographic field. Generally, examples of the charging control agent include a boron compound, nigrosine dye, a quaternary ammonium salt, a triphenylmethane derivative, a salicylic acid zinc complex, a naphthol acid zinc complex, a metal oxide of a benzyl acid derivative, and the like. These charging control agents may be used alone by one kind or as a combination of two or more kinds.

A contained amount of the charging control agent is not particularly limited. Normally, the charging control agent is contained in an amount of 0.5 part by weight to 2.0 parts by weight with respect to 100 parts by weight of the binder resin.

(Release Agent)

According to the toner for electrostatic image development of the present invention, the release agent may be any of hydrocarbon wax such as paraffin wax, polyethylene wax, polypropylene wax, polyethylene-polypropylene wax, Fischer-Tropsch wax, microcrystalline wax, or the like, alcohol-modified hydrocarbon wax, ester wax, carnauba wax, amide wax, and the like. However, from the viewpoint of securement of fixability at a low temperature, the release agent having a melting point of 50° C. to 100° C., and preferably of 60° C. to 90° C. is desirable. From the viewpoint of compatibility with the binder resin and releasability, paraffin wax, Fischer-Tropsch wax, ester wax, or carnauba wax is preferable. The release agents may be used alone by one kind or as a combination of two or more kinds.

(Release Agent Dispersing Aid)

According to the toner for electrostatic image development of the present invention, the release agent dispersing aid is styrene acrylic copolymer resin having at least one of an α-methylstyrene structure and a styrene structure.

Specifically, the release agent dispersing aid is a copolymer obtained by combining α-styrene-[CH₂—C(CH₃)(C₆H₅)]m- or styrene and one kind or two kinds selected from a N-containing vinyl monomer (nitrile), a carboxyl group-containing monomer, an acrylic acid ester monomer (e.g., butyl acrylate), a methacrylate ester monomer (e.g., butyl methacrylate), a methacrylic acid, and the like. The copolymer is not limited to an alternating copolymer.

The styrene acrylic copolymer resin is contained in an amount of 5.5 parts by weight to 12 parts by weight with respect to 100 parts by weight of the polyester resin serving as the binder resin. Further, the styrene acrylic copolymer resin has an acid value of 3 KOHmg/g to 9 KOHmg/g.

<Method for Producing Toner>

The toner of the present invention can be prepared by a grinding process which is preferable in terms of the point that, as compared with a wet process, the grinding process is smaller in number of steps and can be carried out with a smaller amount of capital investment.

The following description discusses a method of the present embodiment for preparing the toner by the grinding process. According to the preparation of the toner, a kneaded product is obtained by blending and melt-kneading toner materials including at least the binder resin, the coloring agent, the release agent, and the charging control agent, the kneaded product is then solidified by cooling and ground, and thereafter size control such as classification or the like is carried out according to need, so that toner particles are obtained.

The blending is preferably dry blending. It is possible to use, as a mixer, a publicly-known mixing device which is commonly used in the technical field. Examples of the mixer include Henschel type mixers such as Henschel mixer (trade name, manufactured by Mitsui Mining Co., Ltd.), Super mixer (trade name, manufactured by Kawata Mfg. Co., Ltd.), Mechanomil (trade name, manufactured by Okada Seiko Co., Ltd.), and the like; and mixers such as Ongmil (trade name, manufactured by Hosokawa Micron Group), Hybridization system (trade name, manufactured by Nara Machinery Co., Ltd.), Cosmo System (trade name, manufactured by Kawasaki Heavy Industries, Ltd), and the like.

It is possible to use, as a kneader, a publicly-known kneading device which is commonly used in the technical field. For example, the kneader is exemplified by general kneaders such as a twin screw kneader, a three-roll mill, a laboratory blast mill, and the like. Specific examples of the kneader include TEM-100B (trade name, manufactured by Toshiba Machine Co., Ltd.); single screw or twin screw extruders such as PCM-65/87 and PCM-30 (trade names, manufactured by Ikegai Corp.), and the like; and open roll type kneaders such as Kneadix (trade name, manufactured by Mitsui Mining Co., Ltd.), and the like. Of these kneaders, an open roll type kneader is preferable in terms of the point that the open roll type kneader is strong in shearing action during kneading and can highly disperse a coloring material such as a pigment, the release agent, and the like.

It is possible to use, as a grinder, a publicly-known grinding device which is commonly used in the technical field. Examples of the grinder include a jet type grinder which carries out grinding by use of a supersonic jet stream and an impact type grinder which carries out grinding by introducing a solidified product into a space formed between a rotator (rotor) which rotates at a high speed and a stator (liner).

It is possible to use, for classification, a publicly-known classification device which is commonly used in the technical field. In particular, it is possible to use a classifier such as a rotary air classifier which can remove overpulverized toner matrix particles by centrifugal force and wind force. Note that the toner to which no external additive has been added is particularly referred to as colored resin particles.

(External Additive)

An external additive is added to the toner of the present invention so that (i) the toner of the present invention improves in carrying property and chargeability and (ii) improves in, for example, stirring property with a carrier in a case where the toner is used as a two component developer.

It is possible to use, as the external additive, a publicly-known external additive which is commonly used in the technical field. Examples of the external additive include silica, titanium oxide, and the like. The external additive is preferably an external additive which is surface-treated (treated so as to be hydrophobized) with silicone resin, a silane coupling agent, or the like.

The external additive is blended in an amount preferably of 1 part by weight to 10 parts by weight, and more preferably of 2 parts by weight to 5 parts by weight, with respect to 100 parts by weight of the colored resin particles.

(Carrier)

The toner of the present invention is used as a two component developer, and a carrier is further blended in the toner. It is possible to use, as the carrier, a publicly-known carrier. Examples of the carrier include a single or composite ferrite carrier containing iron, copper, zinc, nickel, cobalt, manganese, chrome, and/or the like, a resin coated carrier obtained by surface-coating carrier core particles with a coating substance, a resin dispersion type carrier obtained by dispersing magnetic particles into a resin, and the like.

It is possible to use, as the coating substance, a publicly-known coating substance. Examples of the coating substance include polytetrafluoroethylene, a monochlorotrifluoroethylene polymer, polyvinylidene fluoride, silicone resin, polyester resin, a metallic compound of ditertiary butyl salicylic acid, styrene resin, acrylic resin, polyamide, polyvinyl butyral, nigrosine, aminoacrylate resin, basic dye, basic dye lake, silica fine powder, alumina fine powder, and the like. A resin for use in the resin dispersion type carrier is exemplified by, but not limited to styrene acrylic resin, polyester resin, fluororesin, phenol resin, and the like. Any of the resins is preferably selected in accordance with toner components. The resins may be used alone by one kind or as a combination of two or more kinds.

The carrier preferably has a spherical or flat shape. A volume average particle size of the carrier is not particularly limited. In view of an improvement in image quality, the carrier preferably has a volume average particle size preferably of 10 μm to 100 μm, and more preferably of 20 μm to 50 μm. Further, the carrier has a volume resistivity preferably of not less than 10⁸ Ω·cm, and more preferably of not less than 10¹² Ω·cm.

A volume resistivity of the carrier is a value obtained from an electric current value obtained by, after filling carrier particles into a container having a cross section of 0.50 cm² and tapping the carrier particles, causing the carrier particles filled into the container to be under a load of 1 kg/cm², and applying a voltage which causes an electric field of 1000 V/cm between the load and a bottom electrode. In a case where the carrier has a low resistivity, the carrier is charged when a bias voltage is applied to a development sleeve, so that the carrier particles easily adhere to a photoreceptor. Further, a breakdown of a bias voltage easily occurs. The carrier preferably has a saturation magnetization of not less than 40 emu/g and not more than 80 emu/g.

A ratio in which the toner and the carrier are used in the two component developer is not particularly limited, and can be appropriately selected in accordance with respective kinds of the toner and the carrier. For example, in a case where the toner is mixed with a resin coated carrier (having a density of 5 g/cm² to 8 g/cm²), it is only necessary that the toner be contained in an amount of 2 wt % to 30 wt %, and preferably of 2 wt % to 20 wt % of the whole amount of the developer. Further, a ratio in which the carrier is coated with the toner is preferably 40% to 80%.

In order to attain the object, a toner for electrostatic image development of the present invention for use in a trickle developing system developing device, contains: a binder resin; a coloring agent; a charging control agent; a release agent; and a release agent dispersing aid, the binder resin being polyester resin, the release agent dispersing aid being styrene acrylic copolymer resin having at least one of an α-methylstyrene structure and a styrene structure, the release agent dispersing aid being contained in an amount of 5.5 parts by weight to 12 parts by weight with respect to 100 parts by weight of the polyester resin, and the styrene acrylic copolymer resin having an acid value of 3 KOHmg/g to 9 KOHmg/g, and the toner for electrostatic image development having an acid value of 14 KOHmg/g to 19 KOHmg/g.

A toner having the configuration makes it possible to prevent a deterioration in carrier. This allows (i) prevention of a decrease in charged amount, toner scattering, and a deterioration in developability in the trickle developing system developing device and (ii) an increase in image quality in a latter half of a life of the trickle developing system developing device.

A two component developer for supply of the present invention is a two component developer to be supplied to a trickle developing system developing device, containing: the toner for electrostatic image development of the present invention; and a ferrite carrier coated with a resin, the ferrite carrier being contained in an amount of 5 parts by weight to 18 parts by weight with respect to 100 parts by weight of the toner for electrostatic image development.

According to the two component developer for supply, in a case where the carrier is contained in an amount of less than 5 parts by weight, a too small amount of the carrier is replaced, so that charging characteristics etc. cannot be maintained over the life of the developing device. Meanwhile, in a case where the ferrite carrier is contained in an amount of more than 18 parts by weight, an effect is not changed even if a further amount of the carrier is replaced, so that a larger amount of the developer is disposed of.

An image forming method of the present invention includes: forming an electrostatic latent image on a photoreceptor; making the electrostatic latent image visible by supplying toner from a trickle developing system developing device; after transferring an obtained toner image to a transfer medium, causing a fixing device to fix the toner image; and using the two component developer for supply of the present invention.

An image forming apparatus of the present invention includes: a photoreceptor on which an electrostatic latent image is formed; a trickle developing system developing device from which toner is supplied so as to make the electrostatic latent image visible; and a fixing device which is used to fix an toner image that has been transferred to a transfer medium, the image forming apparatus using the two component developer for supply of the present invention.

According to the present invention, an image forming method and an image forming apparatus each using a two component developer for supply of the present invention also fall under the category of the invention.

The present invention is not limited to the description of the embodiments above, but may be altered by a skilled person within the scope of the claims. An embodiment based on a proper combination of technical means disclosed in different embodiments is encompassed in the technical scope of the present invention.

### EXAMPLES

The following description specifically discusses the present invention with reference to Examples and Comparative Examples. However, the present invention is not limited by Examples.

Examples and Comparative Examples measured values of physical properties by the following methods.

[Weight Average Molecular Weight Mw of Binder Resin and Release Agent Dispersing Aid Resin]

A number average molecular weight and a weight average molecular weight are found from a chart showing a molecular weight distribution which is obtained by the following method by use of gel permeation chromatography.

(1) Preparation of sample solution

A resin is dissolved in tetrahydrofuran so that a resultant solution has a concentration of 0.5 g/100 ml. Next, the solution is filtered by use of a fluorine resin filter (FP-200 manufactured by Sumitomo Electric Industries, Ltd.) having a pore size of 2 μm, and an undissolved component is removed. A sample solution is thus prepared.

(2) Measurement of molecular weight distribution

By use of the following measuring device and the following analytical column, tetrahydrofuran is let flow as a solution at a flow rate of 1 ml per minute, and the column is stabilized in a thermostat at 40° C. Measurement is carried out by pouring 100 μl of the sample solution into the solution. A molecular weight of a sample is calculated based on a calibration curve prepared in advance. The calibration curve in this case is prepared using several kinds of mono disperse polystyrene as standard samples.

Measuring device: CO-8010 (manufactured by TOSOH CORPORATION)

Analytical column GMHXL+G3000HXL (manufactured by TOSOH CORPORATION)

[Softening Point Tm of Binder Resin and Release Agent Dispersing Aid Resin]

By use of a rheological characterization device (Flow Tester (model number: CFT-100C) manufactured by Shimadzu Corporation), a load of 20 kgf/cm² (9.8×10⁵ Pa) is applied to 1 g of a sample which is being heated at a temperature increase of 6° C./min, and the sample is let flow out of a die (having a nozzle diameter of 1 mm and a length of 1 mm). A temperature at which a half of the sample has flowed out is referred to as a softening point Tm.

[Glass Transition Temperature Tg of Binder Resin and Release Agent Dispersing Aid Resin]

By use of a differential scanning calorimeter (model number: DSC220 manufactured by Seiko Electronic Industry Co., Ltd. (current Seiko Instruments Inc.)) and in conformity with Japan Industrial Standard (JIS) K7121-1987, a DSC curve is measured by heating 1 g of a sample at a temperature increase rate of 10° C./min. According to the obtained DSC curve, a temperature at an intersection of (i) a straight line obtained by extending a high-temperature side base line of an endothermic peak to a low-temperature side, the endothermic peak corresponding to a glass transition and (ii) a tangent extending from a point where the tangent is the steepest to a curve extending from a rising part to a vertex of the endothermic peak is referred to as a glass transition temperature Tg.

[Melting Point of Release Agent]

By use of a differential scanning calorimeter (model number: DSC220 manufactured by Seiko Electronic Industry Co., Ltd. (current Seiko Instruments Inc.)), a DSC curve is measured by heating 1 g of a sample from a temperature of 20° C. to 200° C. at a temperature increase rate of 10° C./min and carrying out, two times, an operation in which the sample is rapidly cooled from 200° C. to 20° C. A temperature of an endothermic peak corresponding to melting on the DSC curve which is measured at the second time of the operation is regarded as a melting point of the release agent.

[Acid Value of Binder Resin, Release Agent Dispersing Aid Resin, and Toner]

By use of a potentiometric automatic titrator AT-510 manufactured by KYOTO ELECTRONICS MANUFACTURING

CO., LTD., titration was carried out by using THF as a solvent. By using 0.1 mol/L KOH[EtOH] as a titrant, 30 ml of THF was added to 1 g of a sample, and a resultant mixture was stirred with a stirrer for 5 minutes and left to stand in a cool box (10° C.) for a whole day and night. Thereafter, the temperature was reset to a room temperature, and the mixture was titrated by use of the titrator.

### Example 1

Binder resin: 100 parts by weight of polyester resin 1 (having Tg of 67° C., Tm of 125° C., Mw of 65000, and an acid value of 18 KOHmg/g)

Coloring agent: 7 parts by weight of carbon black Release agent: 5 parts by weight of release agent (trade name: WEP-9, manufactured by NOF CORPORATION, and having a melting point of 79° C.)

Charging control agent: 2 parts by weight of boron compound (trade name: LR-147, manufactured by Japan Carlit Co., Ltd.)

Release agent dispersing aid: 6 parts by weight of styrene acrylic (SA) copolymer resin A (trade name: SA800, manufactured by Mitsui Chemicals, Inc., and having Tm of 140° C., Tg of 60° C., Mw of 49000, and an acid value of 6 KOHmg/g)

The above raw materials of a toner were premixed for 10 minutes by use of Henschel mixer, and then a melt kneading dispersion treatment was carried out with respect to the premixed raw materials by use of a kneading dispersion treatment apparatus (Kneadix MOS100-800 manufactured by Mitsui Mining Co., Ltd.), so that a kneaded product was obtained.

The obtained melt-kneaded product was roughly ground by use of a cutting mill and then finely ground by use of a jet grinder (IDS-2-type manufactured by Nippon Pneumatic Mfg. Co., Ltd.). Further, the melt-kneaded product was classified by use of an air classifier (MP-250-type manufactured by Nippon Pneumatic Mfg. Co., Ltd.), so that black colored resin particles were obtained.

Next, 1.9 part by weight of silica serving as an external additive was added to 100 parts by weight of obtained colored resin particles of each of cyan, magenta, and yellow, and a resultant mixture was stirred for 2 minutes by use of an airflow mixer (Henschel mixer manufactured by Mitsui Mining Co., Ltd.) in which a tip speed of a stirring blade was set to 15 m/sec, so that a toner of Example 1 was prepared. The obtained toner had an acid value of 17 KOHmg/g.

### Example 2

Example 2 prepared a toner of Example 2 as in the case of Example 1 except that Example 2 added 9 parts by weight of the styrene acrylic (SA) copolymer resin A serving as the release agent dispersing aid. The obtained toner had an acid value of 16 KOHmg/g.

### Example 3

Example 3 prepared a toner of Example 3 by using, as the release agent dispersing aid, styrene acrylic (SA) copolymer resin B (having Tg of 59° C., Tm of 138° C., Mw of 52000, and an acid value of 4 KOHmg/g) instead of the styrene acrylic (SA) copolymer resin A. Example 3 carried out the preparation as in the case of Example 1. The toner had an acid value of 16 KOHmg/g.

### Example 4

Example 4 prepared a toner of Example 4 as in the case of Example 1 except that Example 4 used, as the release agent dispersing aid, styrene acrylic (SA) copolymer resin C (sample product manufactured by Mitsui Chemicals, Inc., and having Tm of 142° C., Tg of 65° C., Mw of 47000, and an acid value of 8 KOHmg/g) instead of the styrene acrylic (SA) copolymer resin A. The obtained toner had an acid value of 17 KOHmg/g.

### Example 5

By using the polyester resin 1 as the binder resin and adjusting an added amount of the styrene acrylic (SA) copolymer resin A serving as the release agent dispersing aid, Example 5 prepared a toner of Example 5 which toner had an acid value of 15 KOHmg/g. Example 5 added 11 parts by weight of the styrene acrylic (SA) copolymer resin A to 100 parts by weight of the polyester resin 1.

### Example 6

By using, as the binder resin, polyester resin 2 (having Tg of 69° C., Tm of 130° C., Mw of 60000, and 20 KOHmg/g) instead of the polyester resin 1 and adjusting an added amount of the styrene acrylic (SA) copolymer resin A serving as the release agent dispersing aid, Example 6 prepared a toner of Example 6 which toner had an acid value of 18 KOHmg/g. Example 6 added 8 parts by weight of the styrene acrylic (SA) copolymer resin A to 100 parts by weight of the polyester resin 2.

### Comparative Example 1

Comparative Example 1 prepared a toner of Comparative Example 1 as in the case of Example 1 except that Comparative Example 1 added 3 parts by weight of the styrene acrylic (SA) copolymer resin A serving as the release agent dispersing aid. The obtained toner had an acid value of 18 KOHmg/g.

### Comparative Example 2

Comparative Example 2 prepared a toner of Comparative Example 2 as in the case of Example 1 except that Comparative Example 2 added 15 parts by weight of the styrene acrylic copolymer resin A serving as the release agent dispersing aid. The obtained toner had an acid value of 15 KOHmg/g.

### Comparative Example 3

Comparative Example 3 prepared a toner of Comparative Example 3 as in the case of Example 1 except that Comparative Example 3 used, as the release agent dispersing aid, styrene acrylic copolymer resin D (sample product manufactured by Mitsui Chemicals, Inc., and having Tm of 137° C., Tg of 59° C., Mw of 60000, and an acid value of 2 KOHmg/g) instead of the styrene acrylic copolymer resin A. The obtained toner had an acid value of 16 KOHmg/g.

### Comparative Example 4

Comparative Example 4 prepared a toner of Comparative Example 4 as in the case of Example 1 except that Comparative Example 4 used, as the release agent dispersing aid, styrene acrylic copolymer resin E (sample product manufactured by Mitsui Chemicals, Inc., and having Tm of 144° C., Tg of 66° C., Mw of 40000, and an acid value of 11 KOHmg/g) instead of the styrene acrylic copolymer resin A. The obtained toner had an acid value of 18 KOHmg/g.

### Comparative Example 5

By using, as the binder resin, polyester resin 3 (having Tg of 59° C., Tm of 121° C., Mw of 75000, and 13 KOHmg/g) instead of the polyester resin 1 and adjusting an added amount of the styrene acrylic copolymer resin A serving as the release agent dispersing aid, Comparative Example 5 prepared a toner of Comparative Example 5 which toner had an acid value of 12 KOHmg/g. Comparative Example 5 added 8 parts by weight of the styrene acrylic copolymer resin A to 100 parts by weight of the polyester resin 3.

### Comparative Example 6

By using, as the binder resin, polyester resin 4 (having Tg of 71° C., Tm of 133° C., Mw of 560000, and 23 KOHmg/g) instead of the polyester resin 1 and adjusting an added amount of the styrene acrylic copolymer resin A serving as the release agent dispersing aid, Comparative Example 6 prepared a toner of Comparative Example 6 which toner had an acid value of 21 KOHmg/g. Comparative Example 6 added 8 parts by weight of the styrene acrylic copolymer resin A to 100 parts by weight of the polyester resin 4.

(Preparation of Two Component Developer)

Two component developers were prepared by mixing carriers and the toners as prepared above in Examples 1 through 6 and Comparative Examples 1 through 6. A ferrite core carrier, which was used as each of the carriers, had a volume average particle size of 40 μm and a surface provided with a layer covered with thermosetting straight silicone resin. A two component developer having a toner density of 7.5 wt % was obtained by carrying out the mixing by adjusting a density of externally added toner with respect to a total weight of the two component developer to 7.5 wt %.

Table 1 shows results of an evaluation of fixability, evaluations of charging characteristics, toner scattering, and photographic fog together with a comprehensive evaluation. The evaluations of charging characteristics, toner scattering, and photographic fog, and the comprehensive evaluation were carried out as below. First, the evaluations of charging characteristics, toner scattering, and photographic fog were carried out. Then, the two component developer which was evaluated as G (Good) for all the items was evaluated as G (Good) in the comprehensive evaluation. The two component developer which was evaluated as E (Enough) for some of the items but was not evaluated as P (Poor) for any of the items was evaluated as E (Enough) in the comprehensive evaluation. The two component developer which was evaluated as P (Poor) for at least one of the items was evaluated as P (Poor) in the comprehensive evaluation.

[Fixability]

An unfixed image having an adhesion amount of 1.0 mg/cm³ was obtained by using the prepared two component developer in an image forming apparatus (digital full-color multifunction printer: MX-5001FN manufactured by Sharp Corporation) having been modified so as to include a trickle developing device. Subsequently, fixability was evaluated by fixing the unfixed image by use of an external fixing machine. The evaluation was carried out between 140° C. and 220° C. in increments of 5° C. until hot offset occurred. Hot offset is a phenomenon which occurs at a temperature on a high-temperature side at which temperature glossiness deteriorates. A temperature region in which a result of a fix level test is G (Good) and hot offset does not occur is referred to as a fixing band. The two component developer having a 40° C. band was evaluated as “G (Good)”. In the fix level test, an image fixed part was folded with a given load, and a degree of deficiency in image was tested. A result which was equal to or higher in level than that of a standard sample was evaluated as “G (Good)”, and a result which was lower in level than that of the standard sample was evaluated as “P (Poor)”. That is, the two component developer whose fixing band was not less than 40° C. and which was evaluated as “G” in the fix level test was evaluated as “G” for fixability.

Next, 300K sheets were printed by using the prepared two component developer in an image forming apparatus (digital full-color multifunction printer: MX-5001FN manufactured by Sharp Corporation) having been modified so as to include a trickle developing device. Thereafter, the evaluations of charging characteristics, toner scattering, and photographic fog were carried out.

[Charging Characteristics]

The two component developer was sampled at an early stage and after an end of printing (after the 300K sheets had been printed), Q/M was found, and charging characteristics were evaluated based on a difference between a charged amount obtained at the early stage of the printing and a charged amount obtained after the end of the printing. Q=CV was found by pouring a stirred developer into an electromagnetically shielded metallic housing, covering the housing with a metallic mesh, and then sucking toner through the mesh. Q/M [μC/g] was calculated based on Q=CV by measuring an electromotive voltage V at both ends of a known C (electrostatic capacitor C in a measuring machine). Charging characteristics were evaluated as below in accordance with a ratio between the charged amount obtained after the end of the printing and the charged amount obtained at the early stage of the printing.

G (Good): not less than 80%
E (Enough): not less than 60% and less than 80%
P (Poor): less than 60%

[Toner Scattering]

Toner scattering on a developing tank after the end of the printing was visually evaluated.

G (Good): Toner scattering can be seen but is limited.
E (Enough): Toner scattering can be seen and is limited, but occurs in a large amount.
P (Poor): Toner is scattering all over the developing tank.

[Photographic Fog]

A monochrome image was printed after the end of the printing, and an image density of a non-image area was measured. A degree of whiteness W1 of paper which had not been subjected to the printing and a degree of whiteness W2 of a non-image area of the paper which had been subjected to the printing were measured by use of COLOR METER manufactured by NIPPON DENSHOKU INDUSTRIES CO., LTD., and a difference in degree of whiteness between W1 and W2 (W1-W2) was found as photographic fog. Photographic fog was evaluated as below in a monochrome image mode.

G (Good): less than 1.5
E (Enough): not less than 1.5 and less than 2.0
P (Poor): not less than 2.0

TABLE 1

| | 100 parts by weight | | Styrene acrylic | | | | | |
|---|---|---|---|---|---|---|---|---|
| | of polyester resin | | copolymer resin | | | Acid | | |
| | | Acid | | Acid | Added | value of | Evaluation | Charging |
| | Kind | value | Kind | value | amount | toner | of fixability | characteristics |
| Ex. 1 | Resin | 18 | Resin | 6 | 6 pbw | 17 | G | G |
| | 1 | | A | | | | | |
| Ex. 2 | Resin | 18 | Resin | 6 | 9 pbw | 16 | G | G |
| | 1 | | A | | | | | |
| Ex. 3 | Resin | 18 | Resin | 4 | 6 pbw | 16 | G | G |
| | 1 | | B | | | | | |
| Ex. 4 | Resin | 18 | Resin | 8 | 6 pbw | 17 | G | G |
| | 1 | | C | | | | | |
| Ex. 5 | Resin | 18 | Resin | 6 | 11 pbw | 15 | G | G |
| | 1 | | A | | | | | |
| Ex. 6 | Resin | 20 | Resin | 6 | 8 pbw | 18 | G | G |
| | 2 | | A | | | | | |
| Comp. | Resin | 18 | Resin | 6 | 3 pbw | 18 | G | E |
| Ex. 1 | 1 | | A | | | | | |
| Comp. | Resin | 18 | Resin | 6 | 15 pbw | 15 | P | G |
| Ex. 2 | 1 | | A | | | | | |
| Comp. | Resin | 18 | Resin | 2 | 6 pbw | 16 | P | G |
| Ex. 3 | 1 | | D | | | | | |
| Comp. | Resin | 18 | Resin | 11 | 6 pbw | 18 | G | E |
| Ex. 4 | 1 | | E | | | | | |
| Comp. | Resin | 13 | Resin | 6 | 6 pbw | 12 | P | G |
| Ex. 5 | 3 | | A | | | | | |
| Comp. | Resin | 23 | Resin | 6 | 8 pbw | 21 | G | E |
| Ex. 6 | 4 | | A | | | | | |
| | 100 parts by weight | | Styrene acrylic | | | | | |
| | of polyester resin | | copolymer resin | | | | | |
| | | Acid | | Acid | Added | Toner | Photographic | Comprehensive |
| | Kind | value | Kind | value | amount | scattering | fog | evaluation |
| Ex. 1 | Resin | 18 | Resin | 6 | 6 pbw | G | G | G |
| | 1 | | A | | | | | |
| Ex. 2 | Resin | 18 | Resin | 6 | 9 pbw | G | G | G |
| | 1 | | A | | | | | |
| Ex. 3 | Resin | 18 | Resin | 4 | 6 pbw | G | G | G |
| | 1 | | B | | | | | |
| Ex. 4 | Resin | 18 | Resin | 8 | 6 pbw | G | G | G |
| | 1 | | C | | | | | |
| Ex. 5 | Resin | 18 | Resin | 6 | 11 pbw | G | G | G |
| | 1 | | A | | | | | |
| Ex. 6 | Resin | 20 | Resin | 6 | 8 pbw | G | G | G |
| | 2 | | A | | | | | |
| Comp. | Resin | 18 | Resin | 6 | 3 pbw | E | E | E |
| Ex. 1 | 1 | | A | | | | | |
| Comp. | Resin | 18 | Resin | 6 | 15 pbw | E | G | P |
| Ex. 2 | 1 | | A | | | | | |
| Comp. | Resin | 18 | Resin | 2 | 6 pbw | G | G | P |
| Ex. 3 | 1 | | D | | | | | |
| Comp. | Resin | 18 | Resin | 11 | 6 pbw | E | E | E |
| Ex. 4 | 1 | | E | | | | | |
| Comp. | Resin | 13 | Resin | 6 | 6 pbw | G | E | P |
| Ex. 5 | 3 | | A | | | | | |
| Comp. | Resin | 23 | Resin | 6 | 8 pbw | E | E | E |
| Ex. 6 | 4 | | A | | | | | |

″Ex.″ stands for Example.
″Comp. Ex.″ stands for Comparative Example.
″pbw″ stands for parts by weight.

For the toners of Examples 1 through 6, there was no problem with all the items of fixability, charging characteristics, toner scattering, and photographic fog, and a favorable result was obtained.

In contrast, in Comparative Example 1, in which the styrene acrylic copolymer resin was contained in an amount falling below a specified amount, a deterioration was detected in charging characteristics, toner scattering, and photographic fog.

In Comparative Example 2, in which the styrene acrylic copolymer resin was contained in an amount exceeding a specified amount, there was a problem with fixability. This seems to be because the release agent was highly dispersed because the release agent dispersing aid for the styrene acrylic copolymer resin acted too effectively, so that necessary releasability could not be obtained at a high temperature.

Further, the reason why toner scattering occurred in Comparative Example 1, in which the styrene acrylic copolymer resin was contained in a small amount is because particles of the release agent were detached from the toner while the release agent was being stirred for a long term due to its low dispersibility, so that the particles contaminated the carrier. The reason why toner scattering occurred in Comparative Example 2, in which the styrene acrylic copolymer resin was contained in a large amount, seems to be because the toner was high in resistance.

In Comparative Example 3, in which the styrene acrylic copolymer resin was contained in a specified amount but had an acid value falling below a specified value, there was a problem with fixability. Fixability at a high temperature was poor.

In Comparative Example 4, in which the styrene acrylic copolymer resin was contained in a specified amount but had an acid value exceeding a specified value, fixability was favorable, but a deterioration was detected in charging characteristics, toner scattering, and photographic fog.

In Comparative Example 5, in which the styrene acrylic copolymer resin was contained in a specified amount but the toner had an acid value falling below a specified value, photographic fog occurred. This seems to be because the polyester resin 3 used as the binder resin had a too low acid value, so that charging was too high.

In Comparative Example 6, in which the styrene acrylic copolymer resin was contained in a specified amount but the toner had an acid value exceeding a specified value, the chargeability deteriorated, and toner scattering was also detected. This seems to be because the polyester resin 4 used as the binder resin had a too high acid value, so that an affinity for moisture was too high.

### Examples 7 and 8, Comparative Examples 7 and 8

Next, Examples 7 and 8, and Comparative Examples 7 and 8 each evaluated a carrier rate by preparing two component developers for supply by use of the toner of Example 1 and changing a trickle rate which is a ratio in which a carrier is mixed with the toner. The trickle rate is a ratio in which toner is contained in a two component developer to be supplied to a developing tank. For example, in a case where 10 g of a carrier is contained in 100 g of the two component developer to be supplied, the toner is contained in an amount of 90 g, so that the trickle rate is 90%.

Example 7 prepared the two component developer for supply of Example 7 by adjusting the trickle rate so that 7 parts by weight of the carrier was contained in the two component developer with respect to 100 parts by weight of the toner, and Example 8 prepared the two component developer for supply of Example 8 by adjusting the trickle rate so that 15 parts by weight of the carrier was contained in the two component developer with respect to 100 parts by weight of the toner. Similarly, Comparative Example 7 prepared the two component developer for supply of Comparative Example 7 by adjusting the trickle rate so that 3 parts by weight of the carrier was contained in the two component developer with respect to 100 parts by weight of the toner, and Comparative Example 8 prepared the two component developer for supply of Comparative Example 8 by adjusting the trickle rate so that 20 parts by weight of the carrier was contained in the two component developer with respect to 100 parts by weight of the toner.

[Evaluation of Carrier Rate]

Next, 300K sheets were printed by using the prepared two component developer in an image forming apparatus (digital full-color multifunction printer: MX-5001FN manufactured by Sharp Corporation) having been modified so as to include a trickle developing device. After the 300K sheets had been printed, the two component developer was sampled, Q/M was found, and the carrier rate was evaluated based on a difference between a charged amount obtained at an early stage of the printing and a charged amount obtained after the end of the printing. A ratio between the charged amount obtained after the end of the printing and the charged amount obtained at the early stage of the printing was found. A maximum of the ratio between the charged amount obtained after the end of the printing and the charged amount obtained at the early stage of the printing is a minimum required amount of the two component developer. According to this, the carrier rate was evaluated as G (Good) in a case where the ratio between the charged amount obtained after the end of the printing and the charged amount obtained at the early stage of the printing is not less than 80% and less than 95%, and the carrier rate was evaluated as P (Poor) in a case where the ratio between the charged amount obtained after the end of the printing and the charged amount obtained at the early stage of the printing is less than 80% and not less than 95%.

G (Good): not less than 80% and less than 95%
P (Poor): less than 80% and not less than 95%

Table 2 shows a result of the evaluation of the carrier rate.

TABLE 2

| | | Evaluation of |
|---|---|---|
| | Carrier | carrier rate |
| Example 7 | 7 parts by weight | G |
| Example 8 | 15 parts by weight | G |
| Comparative | 3 parts by weight | P |
| Example 7 | | |
| Comparative | 20 parts by weight | P |
| Example 8 | | |

The carrier rates of the respective two component developers for supply of Examples 7 and 8 were favorable. However, in Comparative Example 7, in which the carrier was contained in an amount less than a specified amount, the carrier rate was less than 80%, and in Comparative Example 8, in which the carrier was contained in an amount more than a specified amount, the carrier rate was not less than 80%, so that the developer was wastefully disposed of.

### REFERENCE SIGNS LIST

100 Image forming apparatus
114 Developing device

1. A toner for electrostatic image development for use in a trickle developing system developing device, comprising:
a binder resin; a coloring agent; a charging control agent; a release agent; and a release agent dispersing aid,
the binder resin being polyester resin,
the release agent dispersing aid being styrene acrylic copolymer resin having at least one of an α-methylstyrene structure and a styrene structure, the release agent dispersing aid being contained in an amount of 5.5 parts by weight to 12 parts by weight with respect to 100 parts by weight of the polyester resin, and
the styrene acrylic copolymer resin having an acid value of 3 KOHmg/g to 9 KOHmg/g, or the toner for electrostatic image development having an acid value of 14 KOHmg/g to 19 KOHmg/g.

2. A two component developer for supply to be supplied to a trickle developing system developing device, comprising:
the toner for electrostatic image development recited in claim 1; and a ferrite carrier coated with a resin,
the ferrite carrier being contained in an amount of 5 parts by weight to 18 parts by weight with respect to 100 parts by weight of the toner for electrostatic image development.

3. An image forming method comprising:
forming an electrostatic latent image on a photoreceptor;
making the electrostatic latent image visible by supplying toner from a trickle developing system developing device;
after transferring an obtained toner image to a transfer medium, causing a fixing device to fix the toner image; and
using the two component developer for supply recited in claim 2.

4. An image forming apparatus comprising:
a photoreceptor on which an electrostatic latent image is formed;
a trickle developing system developing device from which toner is supplied so as to make the electrostatic latent image visible; and
a fixing device which is used to fix an toner image that has been transferred to a transfer medium,
the image forming apparatus using the two component developer for supply recited in claim 2.
